(19) United States
(12) Patent Application Publication
(10) Pub. No.: US 2006/0097095 A1
(43) Pub. Date: May 11, 2006

(54) Crusher assembly

(76) Inventor: Ian Boast, Staffordshire (GB)

Correspondence Address: YOUNG & BASILE, P.C., 3001 WEST BIG BEAVER ROAD, SUITE 624, TROY, MI, 48084, US

(21) Appl. No.: 10/523,673

(22) PCT Filed: Aug. 7, 2003
(86) PCT No.: PCT/GB03/03429

§ 371 Date: Oct. 31, 2005

(30) Foreign Application Priority Data
Aug. 7, 2002 (GB) 0218306.9

(51) Int. Cl. B02C 1/02

(52) U.S. Cl. 241/264

(57) ABSTRACT

A jaw crusher (12) comprises a frame 16 having two side walls (22) and a pair of jaws (18, 20) disposed between the side walls (22), which define a crushing chamber (24) for receiving material to be crushed. A deflector plate (28) is pivotably mounted adjacent the outlet of the crushing chamber (24), which is movable under action of hydraulic cylinders (38) for clearing objects which become blocked in the outlet in use. The deflector plate (28) can be mounted on one of the jaws (18), on the frame (16) or on a discharge conveyor (14) positioned below the outlet of the crushing chamber (24).

The present invention relates to a crusher assembly, more particularly, but not exclusively, to a crusher assembly for recycling construction material.

Quarried material is often processed by means of a crushing plant, for the production of aggregate, for example. A crushing plant may also be used for recycling construction materials such as reinforced concrete and timbers embedded in concrete.

A typical crushing plant includes a crushing chamber having a plurality of jaws movable relative to one another, for crushing material present in the crushing chamber, and a conveyor positioned beneath the crushing chamber for receiving material which is discharged during crushing. However, the crushing chamber may become clogged due to the wedging or jamming of material to be crushed between the jaws. In particular, steel components from reinforced concrete material can become jammed between the jaws during recycling, for example. If a steel component becomes jammed in the crushing chamber with an end of the steel component extending from the lower end of the crushing chamber, the extending steel can cause damage to the conveyor positioned beneath the crushing chamber, for example a belt of the convey or can be cut by the steel, thus allowing crushed material to pass through and become clogged in the mechanism of the conveyor.

In such instances, the steel component or the like will often have to be removed manually from the jammed position with cutting torches. Clearing of the crushing chamber in this manner reduces the productivity of the crushing plant and has safety implications for any persons removing such blockages.

It is an object of the invention to provide an improved crusher assembly, for example in which a blockage occurring during the crushing of recyclable material can be cleared mechanically.

According to the present invention, there is provided a crusher assembly comprising a crushing chamber for receiving material to be crushed and having an outlet for discharging material introduced into the crushing chamber, and a plate mounted adjacent the outlet which is movable independently relative to the outlet for clearing objects which become blocked in the outlet in use.

In a preferred embodiment, the plate is mounted for pivotable movement relative to the outlet, for movement against an object projecting from the outlet in use.

Preferably, the crusher assembly includes a hydraulic cylinder arrangement operatively connected to the plate, for powered movement of the plate against an object projecting from the outlet in use, to bend or break the object.

Preferably, the hydraulic cylinder arrangement consists of at least one hydraulic cylinder operatively coupled with a rear surface of the plate.

Preferably, the hydraulic cylinder arrangement includes a hydraulic circuit having a relief valve arrangement for allowing movement of the hydraulic cylinder arrangement under excess pressure conditions.

In a preferred embodiment, the crusher assembly includes a frame having two side walls and pair of jaws disposed between the walls, and the plate is movable independently relative to the jaws.

In a preferred embodiment, the plate is pivotably mounted on one of the jaws. Preferably, the crusher assembly includes a fixed jaw and a swing jaw, and the plate is mounted on the fixed jaw.

In a further embodiment, the crusher assembly includes a frame and the plate is pivotably mounted on the frame.

Conveniently, a discharge conveyor is provided below the outlet for collecting and discharging material passing through the crushing chamber in use.

In a still further embodiment, the plate is pivotably mounted on the discharge conveyor.

Preferably, the plate has a normal operating position in which the plate is angled relative to the outlet for deflecting material which passes through the outlet of the crushing chamber under normal operating conditions.

Preferably, the plate extends at least partially beneath the outlet of the crushing chamber in the normal operating position.

In a preferred embodiment, the plate is movable between an open position, in which the plate extends substantially away from the longitudinal axis of the outlet, and a bending position in which the plate extends substantially across the longitudinal axis of the outlet.

Preferably, the deflector plate includes a wear surface.

According to a further aspect of the invention, there is provided a crusher assembly comprising a frame having two side walls; a pair of jaws disposed between the side walls, the pair of jaws defining a crushing chamber for receiving material to be crushed and having an outlet for discharging material introduced into the crushing chamber; and a plate mounted adjacent the outlet which is movable independently relative to the outlet for clearing objects which become blocked in the outlet in use.

An embodiment of the invention will now be described, by way of example only, with reference to the accompanying drawings, in which:

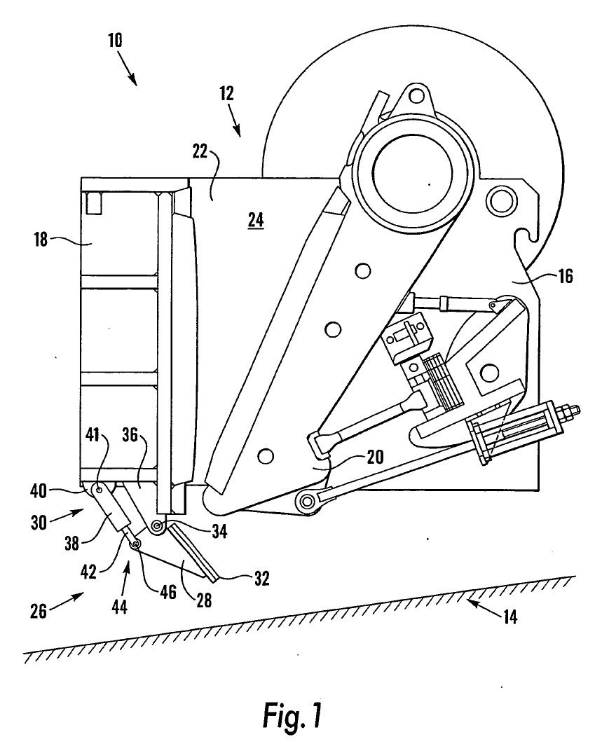

FIG. 1 is a diagrammatic view from the side of part of a preferred embodiment of a crusher assembly according to the invention, showing part of the crusher assembly in cross-section;

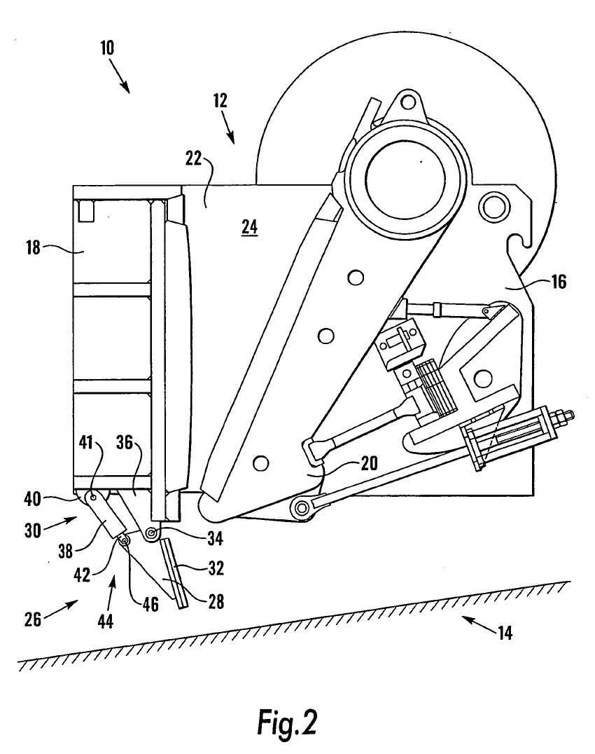

FIG. 2 is a view similar to FIG. 1, showing the deflector plate in an inoperative open position; and

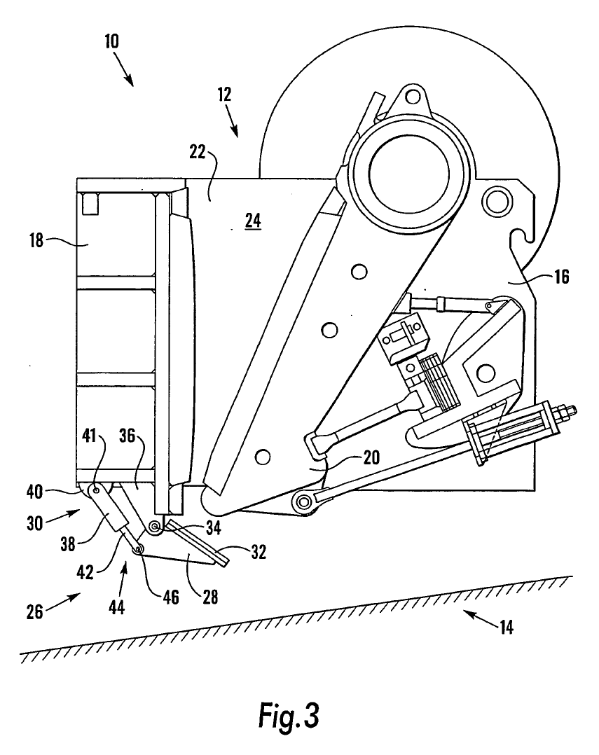

FIG. 3 is a view similar to FIG. 3, showing the deflector plate in a bending position.

A crusher assembly, indicated at 10, includes a crusher 12 for crushing material and a discharge conveyor, indicated at 14, which is positioned below the crusher 12 for collecting and discharging material passing through the crusher 12 in use.

The crusher 12 is of the kind referred to as a jaw crusher, having a frame 16 on which is mounted a fixed jaw 18 and a swing jaw 20. The jaw crusher is of a known construction and will not be described in significant detail. The fixed jaw 18 and swing jaw 20 are supported between opposing walls 22 of the frame 16, only one of which is visible in the figures, and define a crushing chamber 24 for receiving material to be crushed, for example reinforced concrete. The lower end of the crushing chamber, between the lower ends of the jaws 16, 18, defines an outlet through which material may pass during crushing.

The discharge conveyor 14 is a belt conveyor of generally known construction, and will not be described in significant detail.

In the illustrated embodiment, a deflector arrangement, indicated at 26, is provided on the underside of the fixed jaw 18, adjacent the outlet of the crushing chamber 24, which consists of a deflector plate 28 and a hydraulic cylinder arrangement 30 including a hydraulic circuit (not illustrated).

The deflector plate 28 includes a wear surface 32 and extends in a clearance fit between the side walls 22 of the frame 16. The deflector plate 28 is pivoitably mounted on the fixed jaw 18 for independent movement relative to the jaws of the crusher by pins 34, which pass through brackets 36 provided on either side of the spacing between the side walls 22.

The hydraulic cylinder arrangement 30 consists of a pair of hydraulic cylinders 38, only one of which is visible in the figures, operatively connected to the deflector plate 28. The hydraulic cylinders 38 may be double-acting and are arranged with one cylinder 38 positioned on either side of the spacing between the side walls 22, for moving the deflector plate 28, as will be described below. The one end of each cylinder 38 is pivotably connected to a respective plate 40 on either side of the spacing between the sidewalls 22 by pins 41. Each cylinder 38 includes a piston 42 which is reciprocable in the cylinder 38 between a retracted position, as shown in FIG. 2, and a fully extended position, as shown in FIG. 3. As can be seen in the Figures, the distal end of each piston 42 is pivotably connected to a toe 44 of the deflector plate 28 by pins 46.

The hydraulic circuit includes a relief valve arrangement of generally known construction for allowing movement of the hydraulic cylinder arrangement under excess pressure conditions, and will not be described in significant detail.

Under normal operating conditions of the crusher assembly 10, the swing jaw 20 moves in a crushing cycle, up and down, as well as towards and away from the fixed jaw 18. Material to be crushed is introduced into the crushing chamber 24 through the top of the crusher assembly 10. The cyclic movement of the swing jaw 20 causes impelling forces for crushing material present in the crushing chamber 24, and crushed material is then discharged under gravity through the spacing between the lower end of the two jaws 18, 20.

In FIG. 1, the deflector plate 28 is shown biassed by the hydraulic circuit, via the cylinders 38, into a normal operating position. In this position, the deflector plate 28 is angled relative to the outlet and extends at least substantially beneath the area immediately below the outlet of the crushing chamber, for deflecting material which passes through the outlet of the crushing chamber 24 under normal operating conditions. Hence, as material from the crushing chamber 24 passes through the outlet under normal operating conditions, it falls onto the deflector plate 28 and is deflected onto the conveyor 14.

If an object, such as a piece of angled steel from a section of reinforced concrete, or such as a piece of timber, enters the crushing chamber 24 during the crushing cycle, the object may become jammed between the jaws 18,20 and/or the deflector plate 28 in a position extending from the outlet.

If this occurs, the hydraulic circuit can be actuated to operate the cylinders 38 to move to an inoperative open position, as shown in FIG. 2, in which the plate extends substantially away from the longitudinal axis of the outlet, i.e. the plate does not extend substantially across the area immediately below the outlet of the crushing chamber. Hence, it will be understood that the deflector plate 28 to moves independently with respect to the jaws 18,20, relative to the outlet.

Thereafter, in certain circumstances, with the deflector plate 28 effectively moved away from the area immediately underneath outlet of the crushing chamber, continued cyclic action of the swing jaw 20 will be sufficient to enable the jammed object to drop down though the outlet directly onto the discharge conveyor 14 to be discharged, thus removing the blockage.

If the object is of a greater length than the clearance between the bottom of the crusher 12 and the conveyor 14, the object will be unable to drop onto the discharge conveyor and be carried away with the other material passing through the outlet. In such cases, the deflector plate 28 can be moved from the inoperative open position shown in FIG. 1 to a bending position, as shown in FIG. 3, under pressure from the hydraulic cylinders 38, in which the plate extends substantially across the longitudinal axis of the outlet. In this instance, the deflector plate 28 is moved pivotably about pins 34 under action of the hydraulic cylinders, up to a pressure of 200 bar for example, against the blockage. Hence, the object causing the blockage can be bent or broken around the lower end of the swing jaw 20, which acts as a fulcrum, to allow the object to drop down through the outlet onto the conveyor 14.

If the object is of a length whereby, after a first bending about the end of the swing jaw 20, as described above, the object is not cleared from its position extending from the crushing chamber, the hydraulic circuit can be operated to release the pressure in the cylinders to return the deflector plate 32 to the position in FIG. 1 or FIG. 2. Again, cyclic action of the swing jaw 20 enables the object to drop down further through the outlet, whereby the above-described cycle of movement to and from the bending position in FIG. 3 can be continued until the blockage is gradually deformed or broken and finally discharged on to the conveyor 14 for removal.

In alternative embodiments in accordance with the invention, not illustrated, the deflector arrangement is pivotably mounted either on the conveyor 14 or on the frame 16 of the crusher 10.

The invention is of particular advantage, since the plate is movable, independently with respect to the jaws of the crusher, relative to the outlet, to allow the blockage to drop down through the outlet of the crusher and to be moved under action of jaws, and/or to be bent about a fulcrum defined by the jaws of the crusher.

It will be understood that the deflector arrangement described above is suitable for use on any type of crushing plant, such as a rotary crusher.

1. A crusher assembly comprising:
a crushing chamber for receiving material to be crushed and having an outlet for discharging material introduced into the crushing chamber; and
a plate mounted adjacent the outlet which is movable independently relative to the outlet for clearing objects which become blocked in the outlet in use.

2. A crusher assembly as claimed in claim 1, in which the plate is mounted for pivotable movement relative to the outlet, for movement against an object projecting from the outlet in use.

3. A crusher assembly as claimed in claim 1 including a hydraulic cylinder arrangement operatively connected to the plate, for powered movement of the plate against an object projecting from the outlet in use, to bend or break the object.

4. A crusher assembly as claimed in claim 3, in which the hydraulic cylinder arrangement consists of at least one hydraulic cylinder operatively coupled with a rear surface of the plate.

5. A crusher assembly as claimed in claim 3 in which the hydraulic cylinder arrangement includes a hydraulic circuit having a relief valve arrangement for allowing movement of the hydraulic cylinder arrangement under excess pressure conditions.

6. A crusher assembly as claimed in claim 1, including a frame having two side walls and pair of jaws disposed between the walls, in which the plate is movable independently relative to the jaws.

7. A crusher assembly as claimed in claim 6, in which the plate is pivotally mounted on one of the jaws.

8. A crusher assembly as claimed in claim 6 including a fixed jaw and a swing jaw, in which the plate is mounted on the fixed jaw.

9. A crusher assembly as claimed in claim 1 in which crusher assembly includes a frame and the plate is pivotally mounted on the frame.

10. A crusher assembly as claimed in claim 1, in which a discharge conveyor is provided below the outlet for collecting and discharging material passing through the crushing chamber in use.

11. A crusher assembly as claimed in claim 1, in which the plate is pivotally mounted on the discharge conveyor.

12. A crusher assembly as claimed in claim 1, in which the plate has a normal operating position in which the plate is angled relative to the outlet for deflecting material which passes through the outlet of the crushing chamber under normal operating conditions.

13. A crusher assembly as claimed in claim 12, in which the plate extends at least partially beneath the outlet of the crushing chamber in the normal operating position.

14. A crusher assembly as claimed in claim 1 in which the plate is movable between an open position, in which the plate extends substantially away from the longitudinal axis of the outlet, and a bending position in which the plate extends substantially across the longitudinal axis of the outlet.

15. A crusher assembly as claimed in claim 1, in which the plate includes a wear surface.

16. A crusher assembly comprising:
a frame having two side walls;
a pair of jaws disposed between the side walls, the pair of jaws defining a crushing chamber for receiving material to be crushed and having an outlet for discharging material introduced into the crushing chamber; and
a plate mounted adjacent the outlet which is movable independently relative to the outlet for clearing objects which become blocked in the outlet in use.
